(19) United States
(12) Patent Application Publication
(10) Pub. No.: US 2015/0225039 A1
(43) Pub. Date: Aug. 13, 2015

(54) Hand and foot motor driven vehicle particular bicycle

(71) Applicant: Mahmoud Chiniforoushan, Apeldoorn (NL)

(72) Inventor: Mahmoud Chiniforoushan, Apeldoorn (NL)

(21) Appl. No.: 14/405,105

(22) PCT Filed: Jun. 7, 2013
(86) PCT No.: PCT/NL2013/000032

§ 371 Date: Dec. 2, 2014

(30) Foreign Application Priority Data
Jun. 7, 2012 (NL) 1039659

(51) Int. Cl. B62M 1/12; A61G 5/02; B62M 1/30

(52) U.S. Cl. CPC B62M 1/12; B62M 1/30; A61G 5/025

(57) ABSTRACT

Vehicle (1) and (2) with both hand drives (100-1 to 4) and foot drives (200-1 to 4), which must be moved forward and backward by hand drive members (4A, 4A) or foot drive members (5B, 5B), either independently or jointly, to drive the vehicle, in which during both the forward movement and backward movement an operation stroke is made, which powers at least one wheel (13) of the vehicle. The fifth coupling assembly allows the rider to use different ways to drive the vehicle. In motors 2.W, the drive shaft is driven either by the reciprocating movement of the pistons, in which the movement is effectuated by the ignition of fuels and the operation of the second coupling assembly, or by the reciprocating movement of the driving rod 201B and the rotation of the gear that is a freewheel mechanism.

### BACKGROUND

Vehicles of the aforementioned type are known in the state of the art.

### Comparison 1: Bicycle 2.W Versus Bicycle 200910017427.1

The first disadvantage of the known bicycle is that the rider has to perform with his hands two different tasks in one direction with the hand drive member.

First task: in order to drive the vehicle, the hand drive member must be moved forward and backward in a horizontal direction.

Second task: in order to steer the vehicle, the hand drive member must be turned slightly to the right or left slantwise during the reciprocating movement. This means that, when driving the vehicle, the rider has to continuously exert 100% equal force with his hands to both handles. Otherwise, the front wheel will turn to the right or left, without the rider being able to exert any control or having any choice, and both the rider and the bicycle will fall.

Solution: Newly invented bicycles 2.W do not have this disadvantage. In order to drive the vehicle, the hand drive member must be moved forward and backward in a horizontal direction and, in order to steer, the hand drive member must be turned vertically in the opposite direction. As explained on, the rider can also easily perform the above-mentioned tasks with one hand.

The second disadvantage of the known bicycle is that the hands must push the hand drive forward and pull it backward 100% of the fixed length (completely) in order to maintain the constant movement of the bicycle. Otherwise, the crankshaft cannot pass each 180° (halfway round the circle), which means that pulling back the hand drive member before it has been moved completely forward or backward does not have any effect on the crankshaft rotation and the constant movement of the bicycle.

Solution: Newly invented bicycles 2.W do not have this disadvantage. Because of the first coupling assembly 110 the hands can move the hand drive member in another direction at any time, without this having any further effect on the constant movement of the bicycle (explanation to be found on page 6).

### Comparison 2: Bicycles 2.W Versus Bicycle CN201678009 U

The first disadvantage of the known bicycle is exactly the same as the first disadvantage of the known bicycle 200910017427.1, which has been explained above. The rider has to perform with his hands two different tasks in one direction with the hand drive member.

The second disadvantage of the known bicycle is that the hand drive and foot drive are connected with each other. The hand drive is connected with the crankshaft by means of a rod. In order to drive the bicycle, the hands and feet must continuously work together and can never move individually.

Solution: Newly invented bicycles 2.W do not have this disadvantage. In order to drive the vehicle using the third coupling assembly 310, the hand drive and foot drive can be operated both independently and jointly.

### Comparison 3: Bicycles 2.W Versus Wheelchair 101700804a

The disadvantage of the known wheelchair is related to the fact that the rod 4 on the crankshaft is connected with the wheelchair wheel by means of a freewheel mechanism. In order to drive the vehicle, the hands must push the hand drive forward and pull it backward 100% of the fixed length (completely). This is exactly the same disadvantage as the second disadvantage of the known bicycle 200910017427.1, which has been explained above.

### Comparison 4: Bicycles 2.W Versus Bicycle 0085812

The first disadvantage of the known bicycle is that the rider has to perform with his hands two different tasks with the hand drive member. This is exactly the same disadvantage as the first disadvantage of the known bicycle 200910017427.1.

The second disadvantage of the known bicycle is related to the construction and operation of the hand drive member. The rider must pull the steering rod upward and push it downward with his hands. This way of operating the hand drive member has exactly the 100% reverse positive property of lever. The shoulders function as the lever shaft and the rider's hands as the lever head. As the hands and shoulders (lever shaft) are wide apart, the rider cannot exert much force to drive the vehicle.

Solution: Newly invented bicycles 2.W do not have this disadvantage as the hand drive member must be moved forward and backward in the horizontal direction.

### Comparison 5: Bicycles 2.W Versus Tricycle 0069932

The disadvantage of the known tricycle is that it does not have constant movement. An operating stroke is made when the hands pull in the hand drive member (towards the chest) and an idle stroke is made when the feet pull out the foot drive member (forward) in the opposite direction. That is why the drive is not constant.

Solution: Newly invented bicycles 2.W do not have this disadvantage because of the first coupling assembly 110. The reciprocating movements of the hand drive member by the hands and the foot drive member by the feet, both independently from each other and jointly, ensure the constant movement of bicycles 2.W.

### Comparison 6: Bicycle 2.W Versus Bicycle 0197569

The disadvantage of the known bicycle is that it does not have constant movement. The bicycle can only be moved when the hands pull in the hand drive member (towards the chest) and an idle stroke is made when the hand drive member is moved in the opposite direction. That is why the drive is not constant. This vehicle does not have a foot drive. Solution: Newly invented bicycles 2.W do not have this disadvantage because of the first coupling assembly 110. The reciprocating movements of the hand drive member by the hands and the foot drive member by the feet, both independently from each other and jointly, ensure the constant movement of the bicycle.

### Comparison Between Motors 2.W and Current Motors:

Instead of a piston rod and crankshaft in current motors, the present invention uses the second coupling assembly 210 and/or first coupling assembly 110 of the bicycles 2.W to drive the drive shaft of motors 2. Four examples of the benefits of this system in comparison with current motors:

1-Weight, type of material, construction, operation, parts and connection of the crankshaft and piston rod are expensive.

Solution: Constructing the second coupling assembly is not more expensive than constructing the second coupling assembly 210 or the first coupling assembly 110.

2-Friction: in the current motors, when the motor drive shaft makes one rotation, the inner surface of the valve bush and the outer surface of the crankshaft make contact for a complete rotation and because of the little distance between these two surfaces, the oil lubrication cannot be 100% good.

Solution: One rotation of the drive shaft in motors 2.W is divided between all the teeth of the gears of the second coupling assembly 210. As the parts of the second coupling assembly 210 are located in an oil sump (like the differential gears) the friction is almost nil and the parts work properly for a very long time.

3-Because of the friction between the piston rod and the crankshaft, the oil and oil filter must be replaced every couple of thousand kilometers.

Solution: because of the little friction between the teeth of the gears of the second coupling assembly, the oil can be used for a very long time (like the differential oil) and this system does not need an oil filter.

4-maintenance and replacement of the crankshaft, drive shaft and other parts of the current motors, which usually take place around the same time, are expensive.

Solution: replacement of the gears and parts of motors 2.W is very cheap in comparison with the current motors.

### SHORT DESCRIPTION OF THE FIGURES

FIG. 1 is a schematic perspective view of an embodiment of a hand and foot driven vehicle 1 (2.W).

FIG. 2 is a schematic perspective view of an embodiment with an identical version of the hand and foot drive of vehicle 2 (2.W).

FIG. 3 is a schematic top view of the hand and foot drive of vehicle 1 (2.W).

FIG. 4 is a schematic top view of the steering device 400-1 of vehicle 1.

FIG. 5 is a schematic top view of the hand and foot drive of vehicle 2.W. (First bicycle of twin)

FIG. 6 is a schematic top view of the steering device 400-2 of vehicle 2.

FIG. 7 is a schematic top view of the hand and foot drive of vehicle 2.W. (Second bicycle of twin)

FIG. 8 is a schematic top view of the hand and foot drive of vehicle 2.W. (Third bicycle of twin)

FIGS. 9A, 9B are schematic side views of the adjustable system consisting of the hand and foot drive members of vehicle 2.W.

FIG. 10 is a schematic side view of a wheelchair with the hand drive of vehicle 2.W

FIG. 11A is a schematic side view of a first motor 2.W with two cylinders.

FIG. 11B is a schematic top view of a first motor 2.W with two cylinders.

FIG. 12 is a schematic side view of a second motor 2.W with two cylinders.

FIGS. 13A, 13B, 13C are schematic side views of a third motor 2.W with two cylinders.

FIG. 14 is a schematic side view of a fourth motor 2.W with two cylinders.

### DETAILED EXPLANATION OF THE INVENTION

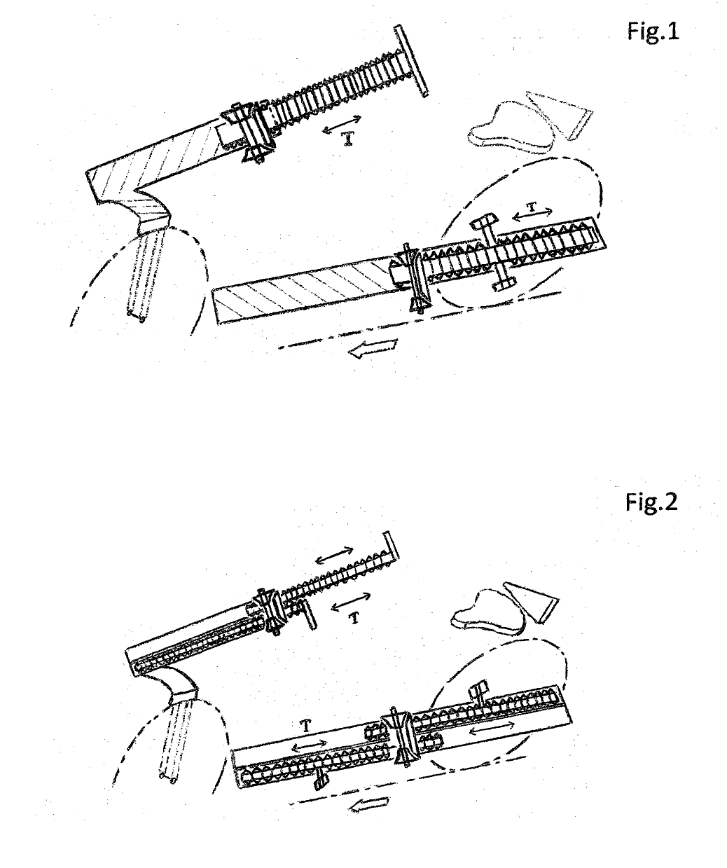

FIGS. 1 and 2 show a schematic perspective view of an embodiment of a hand and foot driven vehicle according to the invention. In the embodiments, the vehicles are shown as a bicycle with a front wheel 13 and a rear wheel 14, of which the rear wheel 13 is driven. It should be noted that the present invention is not limited to rear wheel driven bicycles. For example, the vehicle may also be embodied as a tri-, four- or more wheel version of which one or more wheels are driven.

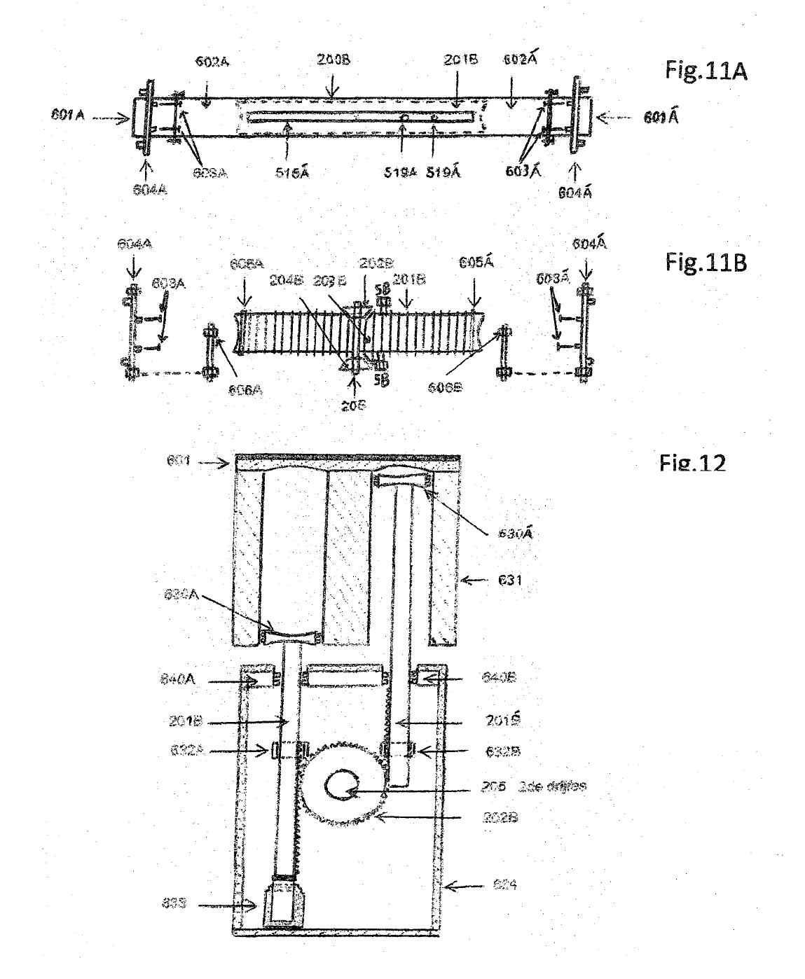

FIGS. 11 to 14 show a schematic perspective view of embodiments of various motors according to the present invention. In the embodiments, the drive shaft 205 is driven by motors 2.W. It should be noted that these motors can drive many different drive shafts of current motors.

The vehicle comprises a saddle 7 equipped with a back 6. In order to drive the vehicle, it is further equipped with four different hand drives 100-1 to 4 and four different foot drives 200-1 to 4. As will be explained below, both drives can be connected to each other, preferably in such a way that the hand drive 100-1 and foot drive 200-1 can be used both independently and jointly to drive the vehicle.

In the order of bicycles 2.W, the construction and operation of hand drives 100-1 to 4 and foot drives 200-1 to 4 will be described first, then the connection of both drives with the rear wheel, then the steering device, then the connection of the hand drives 1 to 4 with the wheelchair, then the fifth coupling assembly and finally the construction and operation of motors 1 to 4 will be discussed.

The embodiments below are only examples. All types of hand drives and foot drives and motors can be embodied by other assemblies.

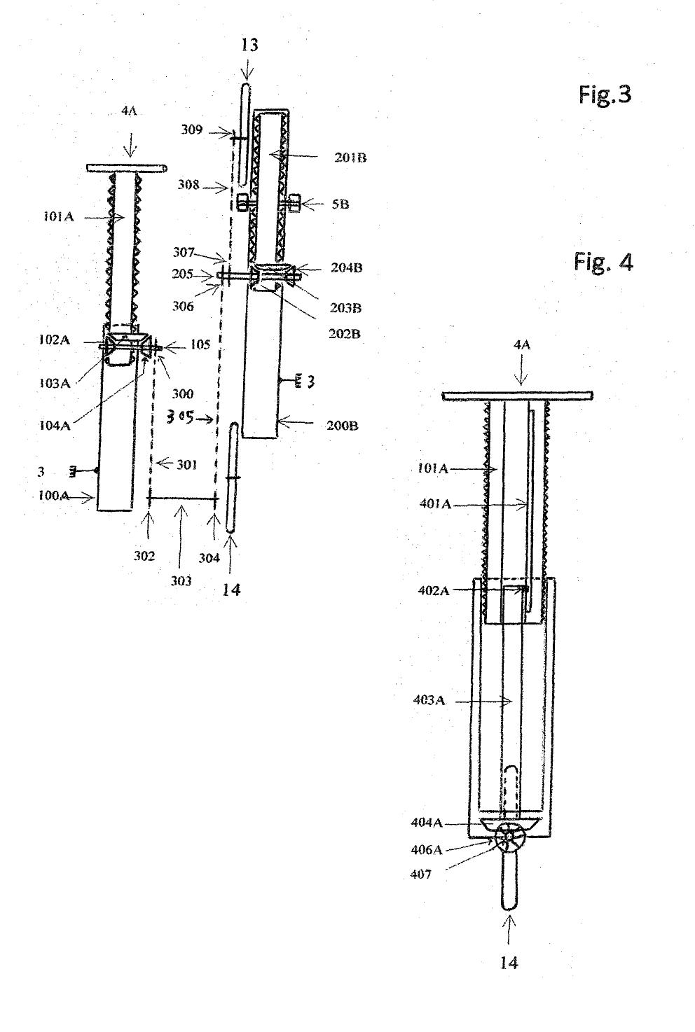

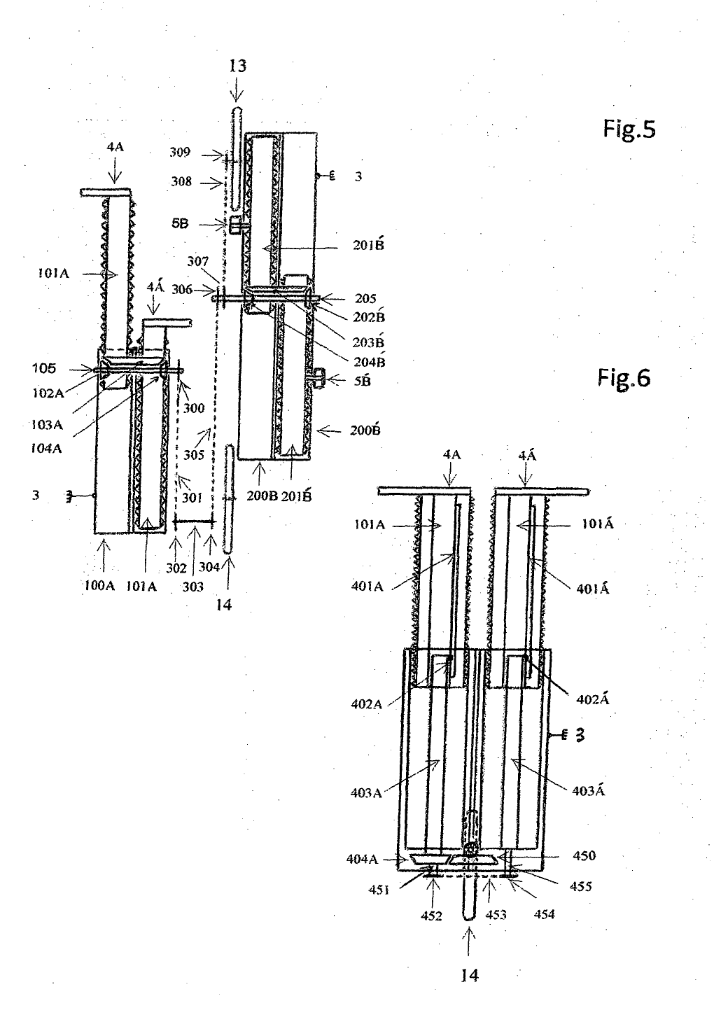

According to the present invention in FIG. 3, the first bicycle 2.W is equipped with a hand drive 100-1 and a foot drive 200-1, of which the hand drive member 4A and foot drive member 5B must be moved in a straight line in a longitudinal direction T to drive the first drive shaft 105.

### Construction of Hand Drive 100-1

The hand drive member 4A is at one end fixedly connected with the driving rod 101A and at the other end located in the bush 100A. The bush 100A ensures that the driving rod 101A always remains in its place. The teeth of the driving rod always make contact with the teeth of the underlying gear of the first coupling assembly 110.

The hand drive member 4A is connected with a substantially laterally extending first drive shaft 105 by means of the first coupling assembly 110. The first drive shaft 105 is bearing-mounted, rotatable around its axis, and connected with the bush 100A of the vehicle. The connection between the hand drive member 4A and first drive shaft 105 as established by the first coupling assembly 110 is such that the first drive shaft 105 is driven in the longitudinal direction T and more particularly in one and the same constant forward rotation direction both during the forward and backward movement of the hand drive member 4A. For this purpose, the first coupling assembly 110 can be designed in various ways.

In the present invention, the first coupling assembly 110 comprises a gear assembly. This gear assembly comprises a first gear 102A which is mounted by means of a freewheel mechanism to the first drive shaft 105 in such a way that it can freely rotate around this shaft in a first rotation direction, while it fixedly engages the first drive shaft 105A in a second rotation direction that is opposite to the first rotation direction and carries it in the forward rotation direction. The gear assembly further comprises a second gear 103A which is mounted by means of a freewheel mechanism to the first drive shaft 105 in such a way that it cane freely rotate around this shaft in a second rotation direction, while it fixedly engages this shaft 105 in a first rotation direction and carries it in the forward rotation direction.

The gear assembly further comprises a third gear 104A that is bearing-mounted to the bush 100A of the vehicle, rotatable around an axis extending substantially perpendicularly to the first drive shaft 105, and that interconnects the first gear 102A and second gear 103A in such a way that the first gear 102 always has a rotation direction that is opposite to that of the second gear 103.

In the present invention, the first, second, and third gears 102, 103, 104 of the gear assembly of the first coupling assembly 110 are conical gears with round teeth. The teeth can have various designs, for example spur teeth, etc.

### The Operation of the Hand Drive 100-1

In use, the rider holds the hand drive member 4A of the vehicle. He then stretches his arms, which involves that the teeth of the driving rod 101A are carried over the first gear 102A.

When the first gear 102A runs free in a backward rotation direction, it will engage the first drive shaft 105 when it is driven in the forward rotation direction and carry it in the forward rotation direction. At the same time, the first gear 102A will drive the second gear 103A in its free-running backward rotation direction through the third gear 104A, which has no further effect.

When the rider has pushed the driving rod 101A over a desired distance, the rider pulls his arms towards his chest, which involves that the teeth of the driving rod 101A are carried over the first gear 102A again, but this time in a backward free-running direction. As a result, the second gear 102A is rotated in a forward rotation direction through the third gear 104A, which again has the effect that the first drive shaft 105 is driven in the forward rotation direction.

In short: by moving the hand drive member 4A forward and backward, the first drive shaft 105 remains rotating in a forward rotation direction. Sometimes this is effectuated by the constant forward rotation of gear 102A and sometimes by the constant forward rotation of gear 103A.

### Foot Drive 200-1

The construction and operation of the foot drive 200-1 for driving the second drive shaft 205 are exactly the same as the construction and operation of the hand drive 100-1, as explained above. The only difference is that the foot drive parts are numbered 200B and higher.

In short: by moving the foot drive member 5B forward and backward, the second drive shaft 205 remains rotating in a forward rotation direction. Sometimes this is effectuated by the constant forward rotation of gear 102B and sometimes by the constant forward rotation of gear 103B.

### Third Coupling Assembly 310

The third coupling assembly 310 is built for driving the vehicle. As has been described above, the first drive shaft 105 is driven by moving the hand drive member 4A forward and backward. By means of the parts of the third coupling assembly 310, numbered 300 to 306, the rotation of the first drive shaft 105 is transferred to the second drive shaft 205 (gear 306 is mounted to the second drive shaft 205 by means of a freewheel mechanism). As has also been described above, the second drive shaft 205 is also driven by the forward and backward movement of the foot drive 5B. The rotation of the first drive shaft and second drive shaft, both independently and jointly, is transferred to the rear wheel 13 by parts 307, 308 and 309 of the third coupling assembly 310 in order to drive the vehicle.

### Steering Device 400-1

This vehicle is further equipped with a steering device 400-1, as shown in FIG. 4. The driving rod 101A is provided with a keyway 401A in the inside (to prevent one end of key 402A from slipping out during the forward and backward movement of the driving rod 101A). The other end of key 402A is fixed to one end of rod 403A. Gear 404 is fixed to the other end of rod 403A (gear 404 is located in bush 100A and has sufficient space on all sides to rotate when the hand drive member 4A rotates).

When the rider turns the hand drive member 4A leftward, the driving rod 101A, key 402A, keyway 401, rod 403A and gear 404A are rotated leftward as well. When gear 404A rotates, gear 406 that is fixedly mounted to the steering housing 407A rotates as well. When the steering housing 407A is rotated, the front fork 8 and front wheel 14 rotate leftward. When the rider turns the hand drive member 4A rightward, all the above-mentioned parts and the front wheel 14 rotate rightward as well.

### Hand Drive 100-2

In the present invention in FIG. 4, the vehicle is equipped with a hand drive 100-2 and a foot drive 200-2. The hand drive members 4A and 4Á and foot drive members 5B and 5\acute{B} must be moved in a straight line in a longitudinal direction T to drive the first drive shaft 105/the vehicle. They are interconnected in such a way that a forward movement of either of them corresponds with a backward movement of the other.

The operation and construction of the hand drive 100-2 are similar to those of the hand drive 100-1 as shown in FIG. 3.

In order to build an identical version of the first coupling assembly 110, the hand drive member 4Á, driving rod 101Á and bush 100Á are needed in addition to the hand drive member 4A, driving rod 101A and bush 100A. The construction of the gear assembly is the same as that of the hand drive 100-1. The teeth of the first gear 102A make constant contact with the teeth of the driving rod 101A and the teeth of the second gear 103A now make contact with the teeth of the driving rod 101Á. The third gear 104 connects the first gear 103A with the second gear 104A in such a way that the first gear always rotates in a rotation direction opposite to that of the second gear and vice versa.

### Foot Drive 200-2

The construction of an identical version of a foot drive 200-2 is exactly the same as the construction of the hand drive 100-2 (as explained above). The only difference is that the foot drive parts are numbered 200B, 200\acute{B} and higher. In order to drive the second drive shaft 205, the rider must move the foot drive members 5B, 5\acute{B} forward and backward with his feet.

The construction and operation of the third coupling assembly 310 to drive the vehicle are exactly the same as those of the third coupling assembly 310 of the hand drive 100-1. The explanation can be found on page 8. This vehicle can be driven by both drives independently or jointly.

### Steering Device 400-2

The steering device 400-2 of FIG. 6 is built to steer this vehicle. The steering device 400-2 is identical to the steering device 400-1, the only difference being that the parts of the identical version are numbered . . . .

The only difference is that the parts of the second version have the same numbers and numbers followed by Á. Furthermore, parts 450 to 455 are used to connect these twin versions.

When the rider turns the hand drive members 4A and 4Á to the right or left, either independently or jointly, the front wheel 14 is turned to the right or left by the same system/operation of the steering device 400-1 (the explanation can be found on page 8).

### Hand Drive 100-3

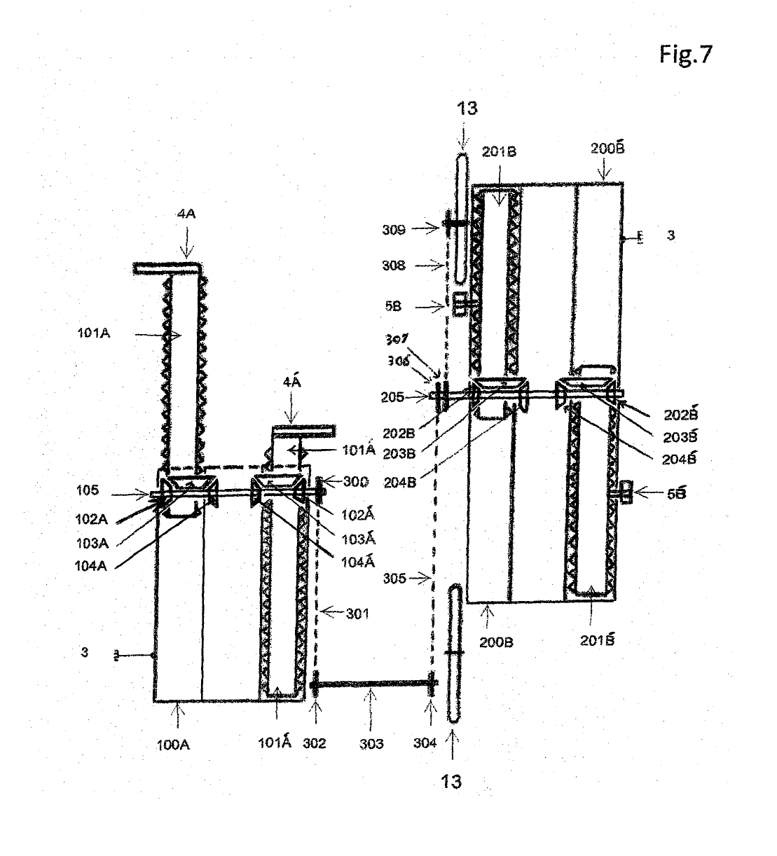

In the present invention in FIG. 7, the vehicle is equipped with a hand drive 100-3 and a foot drive 200-3. The hand drive members 4A and 4Á and foot drive members 5B and 5\acute{B} can be moved forward and backward in a longitudinal direction T in three different ways to drive the first drive shaft 105/the vehicle. These three ways are:
1st with one hand or one foot
2nd with both hands or both feet together
3rd by moving the hands or feet in opposite directions.

Hand drive 100-3 is identical to hand drive 100-1. The construction and operation of this twin version for driving the first drive shaft 105 are exactly the same as those of hand drive 100-1 (the explanation can be found on page 6).

### Foot Drive 200-3

Foot drive 200-3 is identical to foot drive 200-1. The construction and operation of this twin version for driving the second drive shaft 205 are exactly the same as those of foot drive 200-1 (the explanation can be found on page 7).

In order to drive the vehicle, a third coupling assembly 310 is used in this case as well, the construction and operation of which are the same as those of coupling assembly 310 of hand drive 100-1.

The construction and operation of the steering device of this vehicle are exactly the same as those of steering device 400-2 of FIG. 6 (the explanation can be found on page 9).

### Hand Drive 100-4

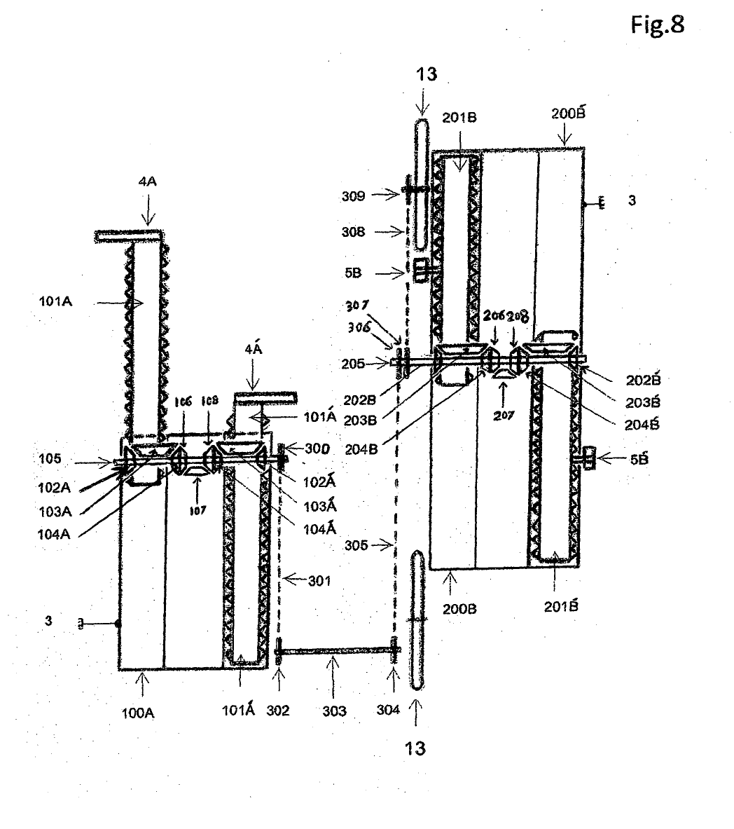

According to the present invention in FIG. 8, this vehicle is equipped with a hand drive 100-4 of which the hand drive members 4A and 4Á can be moved forward and backward in a longitudinal direction T in four different ways to drive the first drive shaft 105/the vehicle. Three of these ways are the same as those of hand drive 100-3. By adding gears 106, 107, 108 to the gear assembly of the first coupling assembly 110, the fourth way of driving is constructed moving forward and backward in the opposite direction corresponding to each other.

Also in this case, hand drive 200-4 is identical to hand drive 100-1. The construction and operation of each hand drive of this twin version for driving the first drive shaft 105 are exactly the same as those of hand drive 100-1 (the explanation can be found on page 6). The construction of the fourth drive is as follows:

Gear 106 is at the rear side permanently connected with gear 104A and gear 107 is at the rear side permanently connected with gear 104Á. Gear 108 (which is connected with bushes 100A and 100Á by means of bearings) ensures that the rotation of gear 106 is transferred to gear 107 and vice versa. If gear 108 is not connected with gears 106 and 107, the vehicle is driven in the other three ways.

The construction and operation of foot drive 200-4 are the same as those of hand drive 100-4, as explained above. The only difference is that the three gears for the fourth way of driving the vehicle are numbered 206, 207, and 208.

Furthermore, in order to drive the vehicle, the third coupling assembly of hand drive 100-1 is used. The construction and operation of the steering device of this vehicle are exactly the same as those of steering device 400-2.

### Fifth Coupling Assembly 510

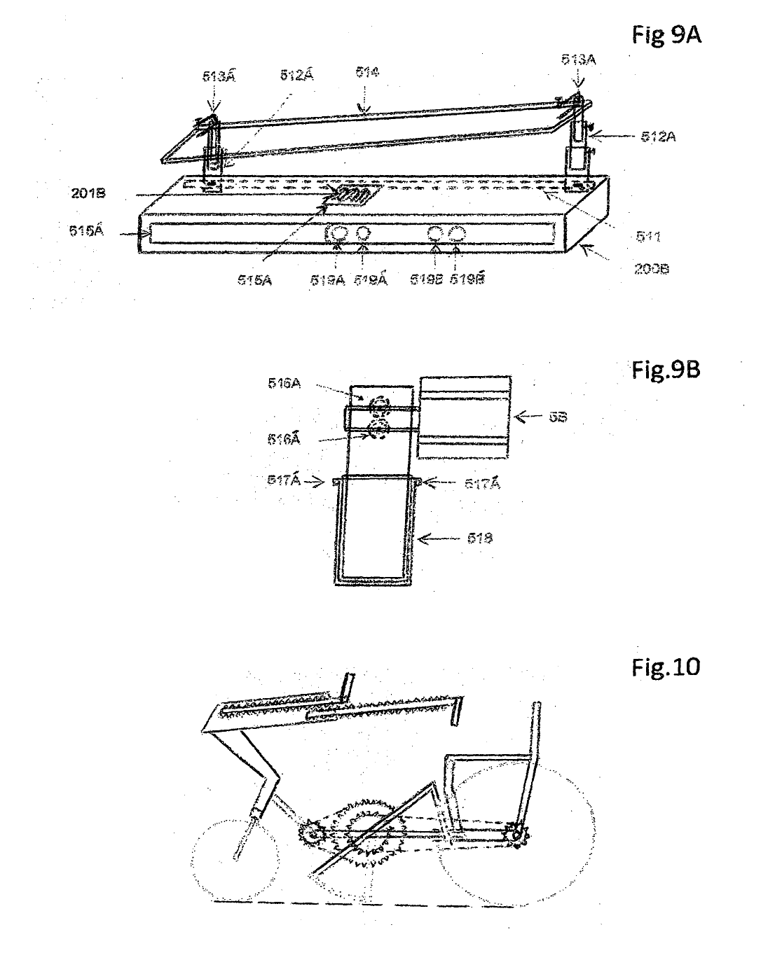

According to the present invention in FIG. 9, the fifth coupling assembly 510 allows the rider to determine in which way the feet move the pedals and the hands move the hand drive member or members in order to drive the vehicle, for example at an angle at various degrees, wave-shaped, etc.

As the length of the pedals can be adjusted for people with foot or hand disabilities, for example people with one shorter leg or shorter arm, they can use bicycles 2.W without any problems.

### Construction of the Fifth Coupling Assembly

Key 509A is fixedly connected at the bottom side of the telescope 512A and key 509Á´ is fixedly connected at the bottom side of the telescope 512Á (there are no restrictions as to the number of telescopes; this depends on which shape the rider has given to the flexible blade 514). Keys 509A and 509Á are located in keyway 511. Telescopes 512A and 512Á can be moved forward and backward in keyway 511 and can be locked at any location on the keyway. Keyway 511 is fixed at the rear side of bush 200B. The length of both telescopes can only be adjusted and locked vertically. Clamp 513A is fixed at the top of telescope 512A and clamp 513Á is fixed at the top of telescope 512Á. One side of the flexible blade 514 is fixed between both clamps and the other (opposite) side is loosely located between the ball bearings 516A, 516Á of telescope 518 in FIG. 9B (telescope 518 can only be extended vertically). Holes 517A, 517Á´ are located at the sides of telescope 518. The drive member 5B is mounted at the top of telescope 518.

Holes 519A, 519Á are located at the side of the driving rod 201B. There are no restrictions as to the number of holes, which allows the rider to lock telescope 518 in any desired hole of the driving rod 201.

Holes 517A, 517Á are fixedly connected with holes 519A, 519Á. Some of the teeth of the driving rod 201B protrude from gap 515A of bush 200B and make contact with the teeth of gear 201B. This fifth coupling assembly is fixed to bush 200\acute{B} using the same construction. This system can also be coupled with all other hand and foot drives of bicycles 2.W with the same construction and operation.

### The Operation of the Fifth Coupling Assembly

In this case, the forward and backward movement of the foot drive member for driving driving rod 201B depends on the shape of the flexible blade 514, which is determined by the feet movements of the rider.

### Construction and Operation of the Wheelchair

According to the present invention in FIG. 10, the wheelchair is equipped with a hand drive 100-2. The wheelchair can be connected to all hand drives 1 to 4 of bicycles 2.W.

Driving the wheelchair using the third coupling assembly for transferring the rotation from the first drive shaft 105 to the rear wheel is effectuated by parts 300 to 304 and 309 (box). The construction and operation are exactly the same as those of the third coupling assembly of hand drive 100-1 of bicycle 2.W.

And steering devices 400-1 and/or 400-2 are used to steer the wheelchair.

### Short Explanation of Motors 2.W

These motors can help the rider to drive the vehicle.

In current motors, the drive shaft is driven by a rod and crankshaft.

In motors 2.W according to the present invention in FIGS. 11, 12, 14, the drive shaft 205 (the shaft of this motor) is driven by the reciprocating movement of the piston or pistons and by the operation of the second coupling assembly 210 of bicycles 2.W, which has the same construction and operation as explained before on page 7. The other parts of these motors are the same as those of various current motors.

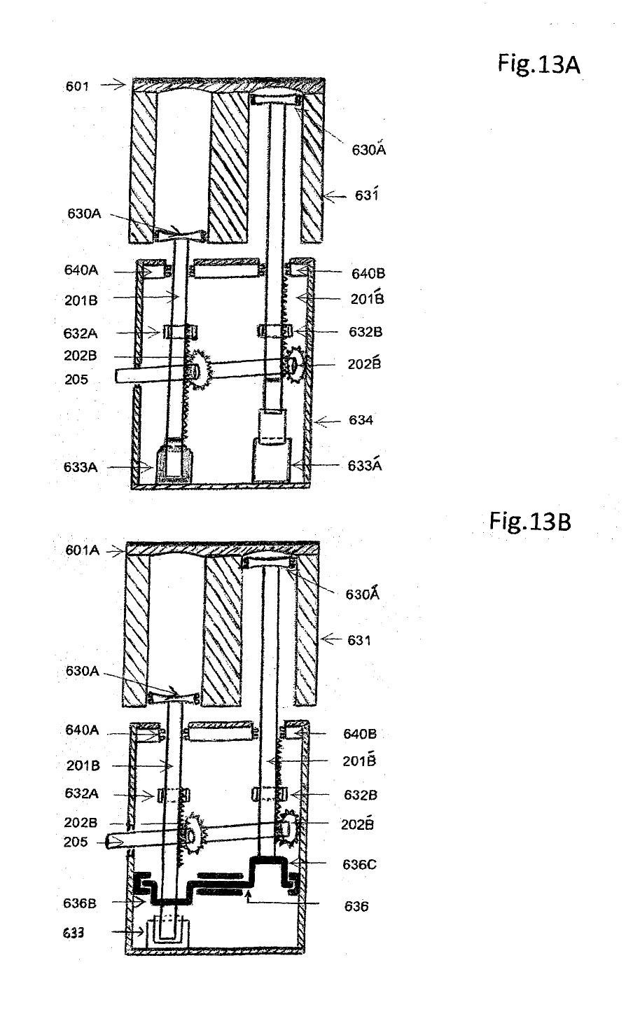

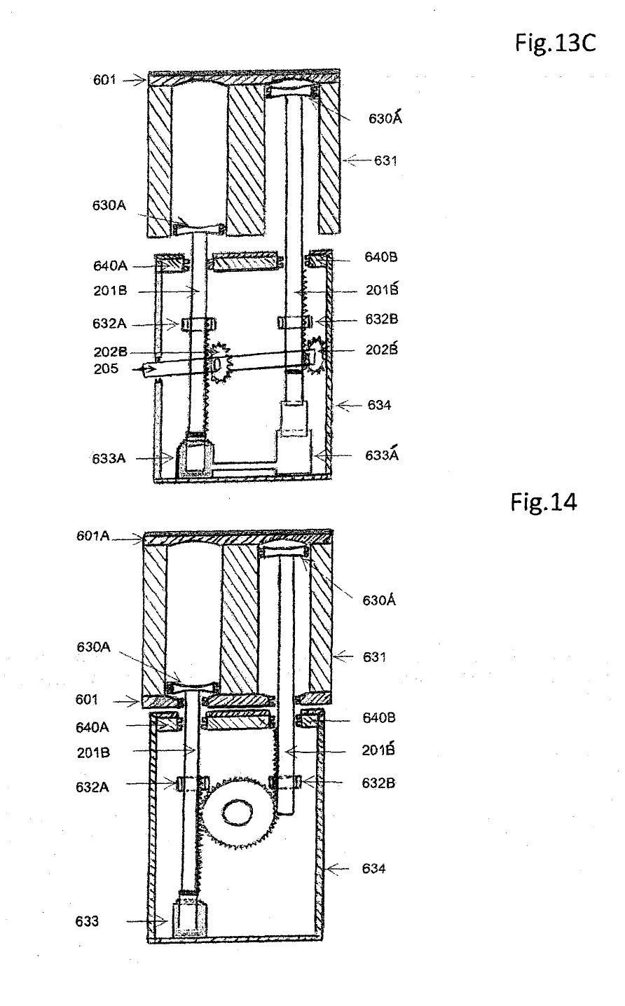

In motors 2.W according to the present invention in FIG. 13, the drive shaft 205 (the motor shaft) is driven by one gear that is fixedly connected with the motor drive shaft by means of a freewheel mechanism.

All motors operate on various fuels.

These motors can be used to drive all bicycles 2.W and to drive the drive shaft of various current motors.

### Construction of First Motor 2.W

In motors 2.W according to the present invention in FIGS. 11A, 11B, the cylinder head 601A is fixed to one end of the bush 200B. The valve 603A and valve shaft 604A are placed at the inside of the cylinder 602A. FIG. 11B shows three keys on the valve shaft 604 and the rotation system of the valve shaft 604. The function of key 1 is to open and close the valve 603. The function of key 2 is to transport the fuel to the piston head. The function of key 3 is to transport electricity for the ignition at the piston head and cylinder 602A. The head of the driving rod 201B is closed (to make it function as a piston for the motor). A ring surrounds the piston 605A. Gear 606A is rotated when the teeth of the driving rod 201B make contact with the teeth of this gear by the reciprocating movement of the foot drive member 5B. When gear 606A rotates, the coupled system and valve shaft 604A rotate as well. The second cylinder head 601Á is fixed at the other end of bush 200B. Adding the above-mentioned parts with the same construction results in a motor with two cylinders.

### The Operation of First Motor 2.W

When the sparking plug is contacted by fuel, this motor is standby. When one end of the driving rod 201B makes contact with the cylinder head 601A, an ignition takes place and as a result, the driving rod is moved. When the other end of the driving rod 201B makes contact with cylinder head 601Á, another ignition takes place and the driving rod 201B moves in the opposite direction. The foot drive member 5B that is fixed to the driving rod 201B moves at the same time.

The vehicle is driven by the reciprocating movement of the driving rod 201B and the rotation of the gear 202B and second drive shaft 205. In order to build this motor with two cylinders, the cylinder heads 601A, 601Á are added to both ends of the bush 200B. The other parts for driving the motor-equipped vehicle are the same as those of the foot drive of bicycle 2.W (the construction and operation of the second coupling assembly 210 can be found on page. The driving rod 201\acute{B} can also drive the drive shaft of this motor using the same construction and operation.

In order to add multiple cylinders to this motor, a second drive shaft is connected to the shaft of this motor.

Construction of Second Motor 2.W with Two or More Cylinders

In motors 2.W according to the present invention in FIG. 12, the piston 630A is at its bottom side fixedly connected to the untoothed end of the driving rod 201B. The bush 200B is located around the driving rod. The other toothed end of the driving rod 201B is inside the bush 200B. The toothed end of the driving rod 201B is fixedly connected with the hydraulic telescope 633. The cylinders 602A, 602Á are located at the other end of the hydraulic telescope 633 and they are fixedly connected to the inside of the oil sump 634.

The piston 630Á is placed in the driving rod 200\acute{B} with the same construction as that of 630A.

Operation of Second Motor 2.W with Two or More Cylinders:

The first ignition at the cylinder head 601A moves the piston and teeth of the driving rod 201B down. As a result, gear 202B is rotated. The rotation of gear 202B moves the teeth at the other side of gear 202B and the teeth of the driving rod 201B and piston 630Á up. The second ignition at the cylinder head 601Á results in a movement in the opposite direction. The negative and positive rotations of gear 202B ensure that the second drive shaft 205 only moves in the forward direction.

In order to add two new pistons, pistons three and four are fixedly connected to the first two pistons in such a way that the teeth of the corresponding drive shafts 201B, 201\acute{B} make contact with both sides of gear 204. In order to add two other pistons with the same construction, pistons five and six are fixedly connected to pistons one, two, three and four in such a way that the teeth of the corresponding driving rod 201B, 201\acute{B}´ make contact with both sides of a gear that is fixed with a suitable distance at the rear side of gear 203.

In order to add more pistons, multiple gears are fixed with a suitable distance at the rear side to second gear 201B.

Another way of adding more pistons is to connect one end of the second drive shaft 205 of this motor to the second drive shaft of the second coupling assembly 210 or multiple coupling assemblies. Subsequent pistons are connected to previous pistons with the same construction and operation as described above. The ignition time of each two pistons that operate in opposite directions and with one gear may be different from the ignition time of two other pistons.

The reciprocating movement of pistons 630A, 630Á is slowed down or stopped by the hydraulic system 633. The force that is saved in this way is used to move the pistons 630A, 630Á.

### Third Motor 2.W

According to the present invention in FIG. 13A, as a result of each ignition of pistons 630A, 630Á for driving the second drive shaft 205, the teeth of the drive shaft 201B, 201\acute{B} cause a separate rotation of gears 202B, 202\acute{B} and each piston is returned by the hydraulic system 633A, 633Á. This motor can have more cylinders with the same construction and operation as described above.

### Third Motor 2.W

According to the present invention in FIG. 13B, both ends of the driving rod 201B, 201\acute{B} are bearing-mounted to the ends of the swing plate 636. When one cylinder moves down the other cylinder moves up because of the operation of the swing plate. The reciprocating movement of the pistons is slowed down or stopped by hydraulic system 633A, 633Á. Each piston is returned by the hydraulic system that is located at the bottom of each piston.

### Third Motor 2.W

According to the present invention in FIG. 13C, hydraulic systems 633A, 633Á are coupled to each other at the sides. As a result, when a piston moves down, the oil in the underlying hydraulic system is pumped and the other piston moves up. The gears of this motor are mounted to the drive shaft by means of a freewheel mechanism.

### Construction of Fourth Motor 2.W in FIG. 14

This motor has the same construction as the motor in FIG. 12.

According to the present invention in FIG. 14, the second cylinder head 601Á is fixedly connected at the bottom side of both cylinders of this motor and can also be fixed to all of the bottom sides of the cylinder or cylinders of motors 2.W. The cylinder head is provided with holes 635A, 635Á. Each hole is surrounded by a ring that was passed through those holes by driving rods 201B, 201\acute{B}.

### Operation of Fourth Motor 2.W

As a result of two ignitions of each piston at the top and bottom side, each piston moves up.

This motor can also be built with more cylinders. Each two cylinders can have different ignition times from the other two cylinders. The hydraulic system 633 slows down the reciprocating movements of all pistons near the end.

Although the present invention was explained hereinabove by some illustrated embodiments, it should be noted that the invention is not limited to these embodiments. A person skilled in the art can make various adjustments and modifications to the described embodiments without leaving the intention and scope of the invention as defined in the following claims.

### LIST OF USED REFERENCE NUMBERS

1 Hand and foot driven vehicle
2 Identical version of a hand and foot driven vehicle
3 Frame
4A, 4Á Hand drive member/steering rod
5B, 5\acute{B} Foot drive member/pedal
6 Back
7 Saddle
8 Front fork
9 Rear fork
13 Rear wheel
14 Front wheel
100-1 Hand drive
100-2 Hand drive
100-3 Hand drive
100-4 Hand drive
100A, 100Á Bush
101A, 101Á Hand driving rod
102A, 102Á First gear
103A, 103Á Second gear
104A, 104Á Third gear
105 First drive shaft
106 Gear
107 Gear
108 Gear
110 First coupling assembly (101, 102, 103, 104)
200-1 Foot drive
200-2 Foot drive
200-3 Foot drive
200-4 Foot drive
201B, 201\acute{B} Foot driving rod
202B, 202\acute{B} First gear
203B, 203\acute{B} Second gear
204B, 204\acute{B} Third gear
205 Second driving rod
206 Gear
207 Gear
208 Gear
210 Second coupling assembly (201, 202, 203, 204)
300 Gear
301 Sprocket
302 Gear
303 Drive shaft
304 Gear
305 Sprocket
306 Gear
307 Gear
308 Sprocket
309 Box
310 Third coupling assembly
400-1, 400-2 Steering device
401A, 401Á Keyway
402A, 402Á Key
403A, 403Á Rod
404 Gear
406 Gear
407 Steering rod
410 Fourth coupling assembly
450 Gear
451 Drive shaft
452 Gear
453 Sprocket
454 Gear
455 Drive shaft
509A, 509Á Key
510 Fifth coupling assembly
511 Keyway
512A, 512Á Telescope
513A, 513Á Clamp
514 Flexible plate
515 Chak
516A, 516Á Ball bearing
517A, 517Á Holes
518 Telescope
519A, 519Á Holes
601A, 601Á First cylinder head, second cylinder head
602A, 602Á Cylinder
603A, 603Á Valve
604 Valve shaft
605A, 605Á Ring
606A, 606Á Gear
630A, 630Á Piston
631A, 631Á Cylinder
632A, 632Á Bush
633A, 633Á Hydraulic telescope
634 Oil sump
635A, 635Á Holes
636 Swing plate
636A,B,C Ball bearing
640A, 640Á Bush
T Longitudinal driving direction

1. A hand and foot driven vehicle (1) and (2), which can be moved by four ways of driving the vehicle, comprising: all hand drives comprise a linearly reciprocable hand drive member (4A) or (4A, 4Á) that is connected with a first rotatable drive shaft (105) by means of a first coupling assembly (110) in such a way that the first drive shaft (105) is driven in a constant forward rotation direction during the forward and backward movement of the hand drive member.
All foot drives comprise a linearly reciprocable foot drive member (5B) or (5B, 5\acute{B}) that is connected with a second rotatable drive shaft (205) by means of a second coupling assembly (210) in such a way that the second drive shaft (205) is driven in a constant forward rotation direction during the forward and backward movement of the foot drive member.
The hand drive (100-1) and foot drive (200-1) can only be moved forward and backward. The hand drive (100-2) and foot drive (200-2) are interconnected in such a way that a forward movement of either of them corresponds with a backward movement of the other.
The hand drive (100-3) and foot drive (200-3) can be moved in three different ways. These three ways are:
1st with one hand or one foot
2nd with both hands or both feet together
3rd by moving the hands or feet in opposite directions.
The hand drive (100-4) and foot drive (200-4) can be moved in four different ways. The first three ways are the three ways of the hand drive (100-3) and foot drive (200-3). The fourth way is the opposite movement that correspond with each other. A third coupling assembly (310) is used for all hand and foot drives. That the first drive shaft (105) and the second drive shaft (205) are connected with the wheel (13) in such a way that at least one wheel can be rotatably driven by the first drive shaft (105) and second drive shaft (205), both independently and jointly.

2. The vehicle according to claim 1, in which the third coupling assembly (310) is arranged to transfer to at least one wheel (13) the sum of the power delivered by the hand drive (100-1 to 4) to the first drive shaft (105) and the sum of the power delivered by the foot drive (200-1 to 4) to the second drive shaft (205).

3. Vehicle according to claim 2, in which the first coupling assembly (110) comprises a first gear assembly:
a first gear (102A) which is mounted by means of a freewheel mechanism to the first drive shaft (105) in such a way that it can freely rotate around this shaft in a first rotation direction, while it fixedly engages the first drive shaft in a second rotation direction that is opposite to the first rotation direction and carries it in the forward rotation direction;
a second gear (103A) which is mounted by means of a freewheel mechanism to the first drive shaft (105) in such a way that it can freely rotate around this shaft in a second rotation direction, while it fixedly engages this shaft in a first rotation direction and carries it in the forward rotation direction;
a third gear (104A) which connects the first gear and second gear with each other in such a way that the first gear always has a rotation direction that is opposite to that of the second gear.

4. Vehicle according to claim 3, in which the second coupling assembly (210) comprises a first gear assembly, which has exactly the same construction as mentioned above, the only difference being that the gears have different numbers: (202B,203B,204B) instead of (102A, 103A, 104A) and the second drive shaft is numbered (205).

5. Vehicle according to claim 4, in which the first coupling assembly (110) comprises: a driving rod (101A) or (101A, 101Á) provided with teeth over the entire length in the longitudinal direction (T), which is at one end fixedly connected with the hand drive member (4A) or (4A, 4Á) and at the other end is located in the bush (100A) or (100A, 100Á), in which the driving rod is mounted in such a way that its teeth are guided over the underlying gear of the first coupling assembly when the driving rod (101A) or (101A, 101Á) is moved forward and backward using the hand drive member (4A) or (4A, 4Á).

6. Vehicle according to claim 5, in which the second coupling assembly (210) comprises: a driving rod (201B) or (201B, 201\acute{B}) provided with teeth over the entire length in the longitudinal direction (T), which is completely located in the bush (200B) or (200B, 200\acute{B}) and which is at one end fixedly connected with the foot drive member (5B) or (5B, 5\acute{B}), in which the driving rod is mounted in such a way that its teeth are guided over the underlying gear of the second coupling assembly if the driving rod (201B) or (201B, 201\acute{B}) is moved forward and backward using the foot drive member (5B) or (5B, 5\acute{B}).

7. Vehicle according to claim 6, in which the fifth coupling assembly (510) comprises: a number of telescopes, the lengths of which can be adjusted, in which the telescopes can be moved forward and backward in the keyway (511) of the bush (200B, 200\acute{B}). At the top of the telescopes, clamps 512A, 512Á are fixedly mounted. One side of the flexible blade (514) is fixed between these clamps and the other side of the flexible blade (514) is loosely located between ball bearings (516A, 516Á). The drive member (5B) is fixed at the top of the telescope. Holes (517A, 517Á) are located at the sides of the telescope (518) and holes (519A, 519Á) are located at the sides of the driving rod (201B). These holes are fixedly connected with each other. The teeth of the driving rod (201B) make contact with the teeth of the gear (201B). The fifth coupling assembly is connected to bush (200B) using the same construction.
This system allows the rider to adjust the length of the telescope and to drive the vehicle with his feet in any desired way.

8. Vehicle according to claim 7, whereby in the current motors the motor shaft is rotated by ignition of various fuels and by the operation of one or two hydraulic systems (633A) and using four different systems of motors 2.W. In all four of the systems, the pistons are moved forward and backward directly.
The first system: has two pistons which allows two ends of one or two cylinders to operate directly with each other.
The second system: both pistons are located in two juxtaposed cylinders.
The third system: the piston moves forward and backward in a cylinder and the piston is returned by the hydraulic system (633A).
The fourth system: one piston in one cylinder which moves the piston forward and backward with two ignitions, the first ignition from the top and the second ignition from the bottom side of the piston.
In the present invention in FIGS. 11 to 14: As the piston or pistons (630A, 630Á) or multiple pistons move forward and backward directly, the movement of the second coupling assembly (210) is connected with the second drive shaft (205) of the motors (which is the same as the second drive shaft (205) of bicycles 2.W) that the forward and backward movement of the driving rod (201B) of the second coupling assembly (210), ??? the second drive shaft (205), which in this case is the motor shaft, only rotates in the forward rotation direction.
The construction and operation for driving the second drive shaft (205) of this motor that is by the second coupling assembly (210) are exactly the same as the construction and operation of the second coupling assembly (210) of the bicycles 2.W, which are explained on page 7. In the motors 2.W of the present invention, each hydraulic system (633A) can perform one or two tasks. The first task is to slow down the reciprocating movement of the piston (630A, 630Á) at the end of each end. The pistons (630A, 630Á) in the motors of FIG. 13 are returned by the swing plate (636) of the hydraulic system (633A). The second task: in one cylinder motor, the pistons (630A, 630Á) are returned by the hydraulic system (633).
In motors according to this claim, the motor shafts can be rotated by two different systems. The first system: by the reciprocating movement of each piston with one gear. The second system: by the operation of each piston in combination with the operation of the second coupling assembly (210). Explanation of the first system: By the reciprocating movements of the pistons (630A, 630Á), the teeth of each driving rod (201B) make contact with the teeth of the gear (202B). As a result, the motor drive shaft is driven (the gears (202B) are fixed to the drive shaft by means of a freewheel mechanism). The piston or pistons (630A, 630Á) may be returned by the hydraulic system (633A, 633Á) or the swing plate (636).
Explanation of the second system: the motor drive shaft is driven by the operation of two pistons in combination with the operation of the second coupling assembly. Explanation of the third system: the reciprocating movements of the piston or pistons may be performed by the second ignition. For this purpose, the second cylinder (601Á), which is engaged in the hole 635, can be mounted to the bottom side of each cylinder. Now, the reciprocating movements of the pistons are effectuated by two ignitions, one at the bottom side and the other at the top side.
